(19) United States
(12) Patent Application Publication
(10) Pub. No.: US 2014/0212836 A1
(43) Pub. Date: Jul. 31, 2014

(54) Composite Capsule and Method for Dispensing a Dental Compound

(71) Applicant: Transcodent GmbH & Co. KG, Kiel (DE)

(72) Inventor: Joachim Fritze, Preetz (DE)

(73) Assignee: Transcodent GmbH & Co. KG, Kiel (DE)

(21) Appl. No.: 14/168,162

(22) Filed: Jan. 30, 2014

(30) Foreign Application Priority Data
Jan. 30, 2013 (DE) 102013201460.0

(51) Int. Cl. A61C 5/04

(52) U.S. Cl. CPC A61C 5/062
USPC 433/90

(57) ABSTRACT

A composite capsule for receiving and dispensing a dental compound. The composite capsule has a receiving space, which is surrounded by a capsule wall and which extends between a discharge opening and a receiving opening, wherein the discharge opening is arranged at a front end of the receiving space, and the receiving opening is arranged at a rear end of the receiving space. The composite capsule comprises a support face, which protrudes outward in relation to the capsule wall and which is oriented in the direction of the front end. The support face is interrupted by a thread recess. By way of the thread recess, the composite capsule can be connected to a storage container, in order to introduce a desired amount of dental compound into the composite capsule.

### BACKGROUND

The invention relates to a composite capsule for receiving and dispensing a dental compound. The composite capsule comprises a receiving space, which is surrounded by a capsule wall and which extends between a receiving opening and a discharge opening, wherein the discharge opening is arranged at a front end of the receiving space, and the receiving opening is arranged at a rear end of the receiving space. A support face, oriented in the direction of the front end, protrudes outward in relation to the capsule wall. The invention also relates to a method for dispensing a dental compound.

Composite capsules of this kind allow a dental compound, of the kind used for filling cavities in teeth for example, to be dispensed specifically at a desired location in the oral cavity of a patient. When pressure is exerted on the dental compound in the receiving space, the dental compound emerges through the discharge opening and can be applied by the dentist to the desired location.

To dispense the dental compound, the composite capsule can be inserted into a dispensing pistol. The dispensing pistol comprises a ram, by means of which the dental compound in the composite capsule can be subjected to pressure, such that it emerges through the discharge opening. By way of the support face, the composite capsule bears on a mating face of the dispensing pistol, as a result of which the composite capsule is held in its position in the dispensing pistol counter to the force of the ram.

The composite capsules are pre-filled units containing a specifically predefined amount of dental compound. Only in a very few cases does this predefined amount of dental compound correspond exactly to the amount required by the dentist. In most cases, excess dental compound is left behind in the composite capsule and has to be disposed of as waste.

### SUMMARY

A composite capsule that can be used in a more versatile way is provided.

In the composite capsule, the support face is interrupted by a thread recess. Thread recess designates an area that lies in a plane of the support face in which a portion of a mating thread is arranged when the composite capsule is brought into engagement with the mating thread.

An underlying concept is that the composite capsules are supplied to the user empty, and the user in each case introduces only so much dental compound into the composite capsule as is needed for the specific application. The composite capsule is designed such that it is easy for the user to introduce the dental compound into the composite capsule. Since the support face is interrupted by a thread recess, it is possible to bring the composite capsule into engagement with a mating thread. By way of the threaded connection, the composite capsule can be brought into engagement with a storage container, for example a storage syringe, such that the desired amount of dental compound can pass from the storage container into the composite capsule. The structure on the outside of the capsule wall is therefore designed such that it performs a dual function. On the one hand, when a force is applied to the composite capsule by a ram of a dispensing pistol, an opposing force is built up via the support face. On the other hand, it is possible, by means of the thread recess, to connect the composite capsule to a storage container via a threaded connection, such that the composite capsule can be filled with the desired amount of dental compound.

Contamination of the storage container, for example by contact with the mouth area of the patient, does not take place on account of conveying the dental compound into the composite capsule, such that dental compound remaining in the storage container can be used in a subsequent treatment. By suitable choice of the amount of dental compound conveyed into the composite capsule, the dental compound is almost completely used up during the treatment, with the result that, upon subsequent disposal or cleaning of the composite capsule, there is no excess dental compound, or only very little excess dental compound, that has to be disposed of.

In an advantageous embodiment, the support face forms the front face of a collar, which extends about the circumference of the composite capsule. The collar has an extent in the longitudinal direction of the composite capsule. If the collar is arranged in the rear area of the capsule, this permits simple handling of the composite capsule during the connection to a storage container or to a dispensing pistol, since a large part of the composite capsule can be gripped all the way round during the connecting procedure.

The support face preferably extends over a circumference angle of at least 45°, more preferably at least 90°, still more preferably at least 120°, without being interrupted by a thread recess. In this way, a large surface area is available via which pressure can be transmitted to a mating face.

The rear face of the collar is preferably provided likewise with a thread recess. The thread recess in the rear face can be arranged offset in the circumferential direction relative to the thread recess in the front face. The thread recesses in the front face and in the rear face can be connected to each other via a thread groove. The area in which a portion of a mating thread can be brought into engagement with the thread of the composite capsule is thereby made larger. This permits a better hold between the composite capsule and the mating thread.

Easier engagement between the composite capsule and the mating thread can expediently be achieved by the support face being provided with a second thread recess, which can be brought into engagement with a corresponding second turn of a mating thread. For the second thread recess, a corresponding thread recess can likewise be provided in the rear face of the collar. The two thread recesses can be connected to a second thread groove. Preferably, the second thread recess of the support face is offset, in the circumferential direction, by an angle of 180° in relation to the first thread recess of the support face.

It is also possible to provide a plunger, which can be introduced through the receiving opening of the composite capsule into the receiving space. The external diameter of the plunger can be adapted to the diameter of the receiving space. The plunger serves to convey the pressure from the ram of the dispensing pistol to the dental compound located in the cylindrical part of the receiving space. The use of the plunger is advantageous since the ram in this way does not come into direct contact with the dental compound and, as a result, does not have to be cleaned. The dental compound is introduced into the receiving space when the plunger is not in the receiving space.

The composite capsule can be produced as a one-piece injection-molded part from a plastics material. The material surrounding the receiving space can be transparent, such that it is possible to see from the outside how much dental compound is contained in the receiving space. In order to protect the dental compound from incident light, the transparent material can be colored.

The capsule wall can have a portion in which the material of the capsule wall is transparent. In the transparent portion, it is possible to see through the material of the capsule wall into the receiving space and, for example, to identify how much dental compound is contained in the receiving space. The transparent portion can partially or completely cover the receiving space with respect to the longitudinal axis of the receiving space. In the circumferential direction, the transparent portion can likewise partially or completely cover the receiving space. The composite capsule can be made wholly of transparent material.

In the transparent portion, the material of the capsule wall can be designed as an optical filter that blocks short-wave components of visible light and that transmits long-wave components of visible light. The transition range between the blocking range and the transmitting range can lie, for example, at between 500 nm and 600 nm. The transparent material can look orange to an observer. Preferably, the optical filter also blocks UV light. The blocking range of the optical filter can, for example, comprise the wavelength range of 370 nm to 520 nm. Such a filtering effect of the transparent material is particularly advantageous if the dental compound in the receiving space cures under UV light. Such dental compounds are dispensed in the liquid or pasty state and are then cured in a short time by irradiation with UV light. As long as the dental compound is contained in the receiving space, no curing should take place. The filtering action of the transparent material protects the dental compound not only from UV light, but also from the short-wave components of visible light, as a result of which the risk of inadvertent curing is reduced.

The composite capsule can be provided with a scale, from which the amount of dental compound contained can be read off. The receiving space can have a volume of between 0.1 ml and 0.5 ml, for example. Preferably, the volume of the receiving space is between 0.12 ml and 0.2 ml.

The receiving space can have a first portion, in which the receiving space is cylindrical. The diameter of the cylindrical portion is preferably adapted to the diameter of the plunger. Between the receiving opening and the cylindrical portion, the receiving space can have a second portion, in which the interior widens in the direction of the receiving opening. The first portion merges into the second portion preferably without any step. On the one hand, such widening makes insertion of a plunger easier. On the other hand, the storage container can be provided with a tip which matches the widening, such that the composite capsule can be fitted easily onto the storage container. The tip of the storage container is preferably dimensioned such that the emerging dental compound passes into the cylindrical portion of the receiving space. A receiving space that widens in the direction of the receiving opening may have its own inventive merit, even without the support face being interrupted by a thread recess.

To be able to dispense the dental compound in a specific manner, it is advantageous if the composite capsule has, at its front end, a dispensing tip. The dispensing tip can taper in the direction of the discharge opening. The dispensing tip is preferably inclined relative to the longitudinal axis of the receiving space. For example, the inclination can be such that the axis of the dispensing tip encloses an angle of between 20° and 80° with the axis of the receiving space. A channel is expediently located inside the dispensing tip and extends from the receiving space as far as the discharge opening. The channel can, for example, have a diameter of between 1 mm and 3 mm, preferably of between 1.2 mm and 2.5 mm. Preferably, the channel has a constant diameter between the receiving space and the discharge opening. To be able to dispense the dental compound even more precisely, the dispensing tip can be provided with a needle through which dental compound moves.

The dispensing tip can be oriented such that there is an intersection between a projection of the dispensing tip into the plane of the support face and a projection of the thread groove into the plane of the support face. More preferably, the projection of the dispensing tip intersects the thread recess in the support face. Such an orientation of the dispensing tip is advantageous in the sense of a favorable orientation of the composite capsule inside the dispensing pistol, since the support face, in the areas of greatest force transmission, is then not interrupted by the thread recess.

In order to close the composite capsule at its discharge opening and to protect dental compound located in the composite capsule from ambient air, a matching cap can be provided, which can be fitted onto the dispensing tip of the composite capsule.

The invention also relates to a system composed of a storage syringe and of such a composite capsule. The storage syringe forms a storage container for the dental compound, from which the desired amount of dental compound can be transferred into the composite capsule. The storage syringe can have a mating thread that matches the thread recess of the composite capsule and that is arranged around a discharge opening of the storage syringe. By way of the thread recess and the mating thread, the composite capsule can be connected to the storage syringe. Dental compound emerging from the discharge opening of the storage syringe then passes into the receiving space of the composite capsule. The mating thread can be designed as a standardized Luer lock thread, and the thread recess of the composite capsule can be designed such that it forms a threaded connection with the Luer lock thread.

The discharge opening of the storage syringe is preferably arranged on a tapering tip of the storage syringe, wherein the tip more preferably tapers in a cone shape. The mating thread can be arranged on an envelope surface surrounding the tip, wherein the storage syringe can be designed such that the collar of the composite capsule is arranged between the tip and the envelope surface when the threaded connection is in engagement.

The cone shape of the tip of the storage syringe can correspond to the standardized Luer cone. The widening portion of the receiving space of the composite capsule can be adapted to the cone shape of the tip, such that planar contact is obtained when the composite capsule is fitted onto the tip. The tip can be longer than the widening portion, such that the front end of the tip extends into the cylindrical portion of the receiving space. Preferably, so much dental compound is contained in the storage syringe that it is sufficient to fill several composite capsules.

In addition to the composite capsule and the storage syringe, the system can comprise a dispensing pistol. The dispensing pistol can be equipped with a capsule receiver for the composite capsule, wherein the capsule receiver has a mating face cooperating with the support face of the composite capsule. When the composite capsule is inserted into the capsule receiver, pressure can be exerted on the receiving space of the composite capsule by a ram, such that the dental compound emerges at the front end of the composite capsule. By way of the mating face and the support face, the composite capsule is held in position counter to the pressure of the ram.

The mating face is preferably provided with a recess through which the composite capsule can be guided in the radial direction, in order to insert the composite capsule into the capsule receiver. The capsule receiver can be designed such that it engages around the composite capsule in the manner of a snap-fit arrangement. When the composite capsule is inserted into the capsule receiver, the thread groove of the support face is preferably arranged in the area of the recesses of the mating face. This has the advantage that the support face cooperates with the mating face via those areas that are not weakened by the thread groove.

The invention also relates to a method for dispensing a dental compound. In the method, a composite capsule is attached to a storage container, wherein the composite capsule is connected to the storage container by a threaded connection. Dental compound is dispensed from the storage container, such that the dental compound passes into a receiving space of the composite capsule. The receiving space is closed with a plunger. The composite capsule is inserted into a capsule receiver of a dispensing pistol. The dispensing pistol is actuated in order to exert pressure on the plunger.

First of all, the empty composite capsule is connected to the storage syringe by means of the thread recess of the composite capsule being brought into engagement with the matching mating thread of the storage syringe. By exerting pressure on the dental compound located in the storage syringe, an amount of dental compound suitable for the dental treatment is conveyed into the composite capsule. The connection between composite capsule and storage syringe is then released, and a plunger is introduced through the receiving opening of the composite capsule into the receiving space. Thereafter, the composite capsule is inserted into the matching receiver of the dispensing pistol, and a mechanism for moving the ram in the direction of the composite capsule is actuated. The ram then moves through the receiving opening of the composite capsule into the receiving space and exerts pressure on the plunger and on the dental compound located behind the latter, which dental compound moves in the direction of the discharge opening. The actuation of the mechanism for moving the ram is metered such that a suitable amount of dental compound emerges from the discharge opening.

### BRIEF DESCRIPTION OF THE DRAWINGS

The invention is described below on the basis of advantageous illustrative embodiments and with reference to the attached drawings, in which:

FIG. 1 shows a side view of a composite capsule, which composite capsule is inserted into a dispensing pistol;

FIG. 2 shows an enlarged view of the capsule receiver of the dispensing pistol from FIG. 1;

FIG. 3 shows a side view of a composite capsule, which composite capsule is connected to a storage syringe;

FIG. 4 shows a sectional view of a composite capsule;

FIG. 5 shows a top view of a composite capsule;

FIG. 6 shows the composite capsule from FIG. 5 in a view from the front.

### DETAILED DESCRIPTION

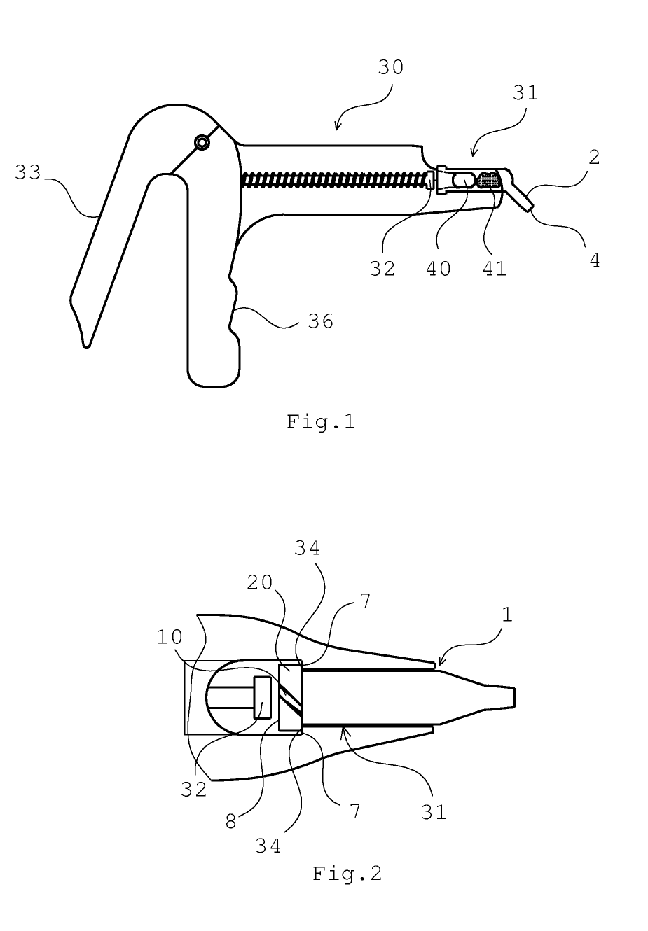

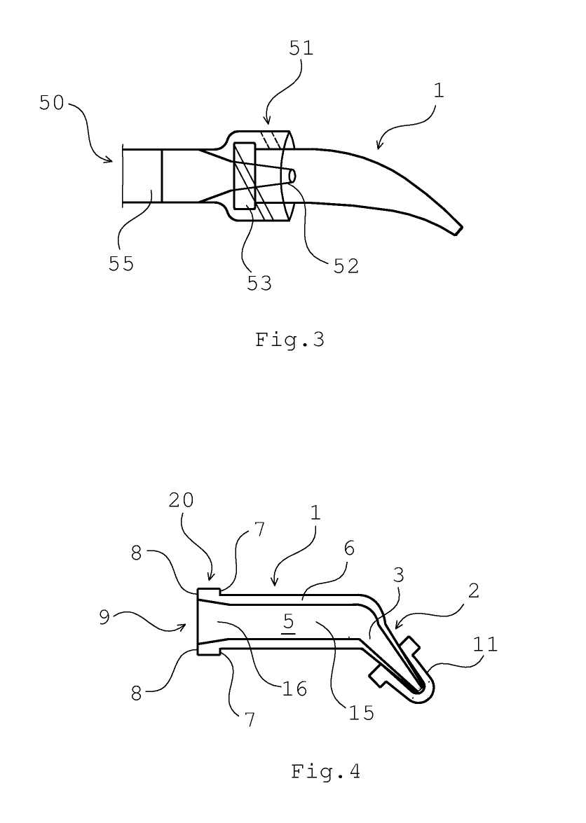

A system comprises, as shown in FIGS. 1 and 3, a composite capsule 1, a dispensing pistol 30 and a storage syringe 50. In FIG. 2, the composite capsule 1 is connected to the dispensing pistol 30. The dispensing pistol 30 comprises a mechanism 33 by which a ram 32 is pressed in the direction of a capsule receiver 31 arranged at the front end of the dispensing pistol 30. Moreover, the dispensing pistol 30 comprises a grip 36, which extends in the radial direction. The front face of the ram 32 is circular and has a diameter that is slightly smaller than the internal diameter of a receiving space 5 of the composite capsule 1. The ram 32 and the receiving space 5 of the composite capsule 1 are arranged such that, upon actuation of the mechanism 33, the ram 32 enters the receiving space 5 and exerts pressure on the plunger 40 arranged therein. The plunger 40 is thereby moved in the direction of the dispensing tip 2 of the composite capsule 1 and thus likewise conveys the dental compound 41, located in the receiving space, in the direction of the dispensing tip 2. When the plunger 40 has been pressed sufficiently far in the direction of the dispensing tip 2 by the ram 32, the dental compound 41 emerges from the discharge opening 4. It is easy for the dentist to dispense dental compound in this way in the mouth of a patient.

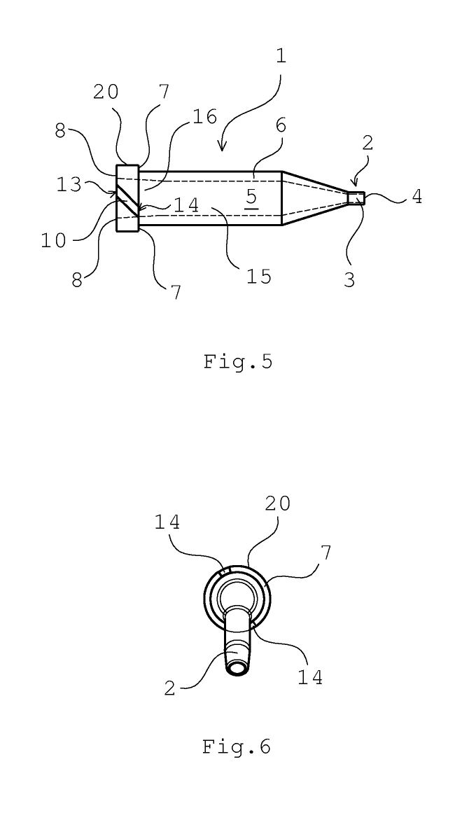

The composite capsule 1 comprises, as shown in FIGS. 4 and 5, a receiving space 5, which is delimited by a wall 6. The dispensing tip 2 is located at the front end of the receiving space 5 and encloses an angle of ca. 45° with the longitudinal axis of the receiving space 5. The receiving opening 9 is arranged at the rear end of the receiving space 5. The receiving space 5 has a front portion 15, in which the wall face is shaped cylindrically, and a rear portion 16, in which the wall face widens in the direction of the receiving opening 9. The dispensing tip 2 comprises a channel 3, which extends from the receiving space 5 as far as the discharge opening 4 arranged at the front end of the dispensing tip 2. According to FIG. 6, there is an intersection between the dispensing tip 2 and one of the thread recesses 14 when the dispensing tip 2 is projected into the plane of the support face.

At the rear end of the receiving space 5, a collar 20 protrudes radially outward. The collar is interrupted by two thread grooves 10, of which only one can be seen in FIG. 5. The second thread groove is offset by 180° with respect to the first thread groove in the circumferential direction about the collar. The thread grooves 10 enclose an acute angle with the longitudinal axis of the composite capsule. Apart from the thread grooves 10, the collar 20 has a cylindrical outer face, wherein the cylinder axis is oriented along the longitudinal axis of the receiving space 5.

The composite capsule is produced as a one-piece injection-molded part from a transparent plastics material. The plastics material acts as an optical filter that blocks short-wave visible light and UV light and transmits long-wave visible light. The optical filter is designed as a cut-off filter with a sharp transition between the transmission range and the blocking range. The transition between the transmission range and the blocking range lies at approximately 520 nm. The composite capsule looks orange to an observer. The receiving space 5 has a volume of 0.19 ml.

The collar further comprises a support face 7 directed toward the front end of the composite capsule 1, and a rear face 8 directed toward the rear. The thread groove 10 opens out in the rear face 8 in a thread recess 13, and in the support face 7 in a thread recess 14.

The composite capsule 1 is supplied empty to the user, and it is only filled with a desired amount of dental compound by the user. When the dental compound has been introduced into the receiving space 5, a plunger 40 is inserted through the receiving opening 9, such that the receiving space 5 is closed off. When pressure is exerted on the plunger 40 by the ram 32 of the dispensing pistol 30, the plunger 40 moves forward and forces the dental compound in the direction of the discharge opening 4. If the dental compound 41 is not to be used immediately, the discharge opening 4 can be closed with a cap 11.

To introduce the dental compound, the composite capsule 1, as shown in FIG. 3, is connected to a storage syringe 50, which contains a supply of dental compound. The storage syringe 50 has, at its front end, a cone-shaped tip 52. Extending around the cone-shaped tip 52 is an envelope surface 56, on the inner side of which a two-start thread 53 is formed. The cone-shaped tip 52 and the thread 53 are dimensioned so as to comply with the Luer lock standard. The portion 16 of the receiving space 5 of the composite capsule 1 is adapted to the Luer cone, i.e., lies flat on the tip 52. The front end of the tip 52 protrudes into the portion 15 of the receiving space 5.

The connection between the composite capsule 1 and the storage syringe 50 is produced by bringing the thread grooves 10 of the composite capsule 1 into engagement with the thread 53 of the storage syringe 50. The cone-shaped tip 52 then protrudes into the receiving space 5 of the composite capsule 1. When pressure is exerted by the plunger 55 on the dental compound 54 located in the storage syringe 50, the dental compound 54 emerges through the opening of the cone-shaped tip 52. The composite capsule 1 is thus filled with a desired amount of the dental compound 54. After the composite capsule 1 has been filled, it is separated from the storage syringe 50, and the plunger 40 is introduced through the receiving opening 9 of the composite capsule 1.

To dispense the dental compound in the mouth of a patient, the composite capsule 1 is then inserted into the capsule receiver 31 of the dispensing pistol 30. In FIG. 2, the capsule receiver 31 is shown in a view from above. In this view, the dispensing tip 4 of the composite capsule 1, which is pointing downward in FIG. 1, is directed in the plane of the drawing. The capsule receiver 31 comprises an insertion shaft for the composite capsule 1, into which insertion shaft the composite capsule 1 can be inserted from above. The lateral faces of the capsule receiver define the orientation of the composite capsule 1 and are designed such that the composite capsule 1 locks in place with a snap fit. The longitudinal extent of the lateral faces is smaller than the distance between the support face 7 and the front end of the composite capsule 1. The capsule receiver 31 also comprises an end face 34, on which the support face 7 bears when the composite capsule 1 is inserted into the capsule receiver 31. The end face 34 thus forms a mating face for the support face 7. It is thus ensured that the composite capsule 1 is not pressed forward by the ram 32.

When the composite capsule 1 is inserted correctly into the capsule receiver 31, the dispensing tip 2 of the composite capsule 1 points in the same direction as the grip 36 of the dispensing pistol 30. One of the thread grooves 10 then lies, as shown in FIG. 2, in the area of the capsule receiver 31 in which the support face 7 does not bear on the mating face 34. At the location where the forces are transmitted between the support face 7 and the mating face 34, the collar 20 is not weakened by a thread groove.

The collar 20 of the composite capsule 1 thus has a dual function since, on the one hand, it bears on the mating face 34 of the dispensing pistol 30 and, on the other hand, it permits the threaded connection to the thread 53. Moreover, the receiving space 5 of the composite capsule 1 is designed such that it lies flat on the cone tip 52 of the storage syringe 50.

1. A composite capsule for receiving and dispensing a dental compound, with a receiving space, which is surrounded by a capsule wall and which extends between a discharge opening and a receiving opening, wherein the discharge opening is arranged at a front end of the receiving space, and the receiving opening is arranged at a rear end of the receiving space, and with a support face, which protrudes outward in relation to the capsule wall and which is oriented in the direction of the front end, characterized in that the support face is interrupted by a thread recess.

2. The composite capsule as claimed in claim 1, characterized by a collar extending about the circumference of the receiving space, wherein the support face forms the front face of the collar.

3. The composite capsule as claimed in claim 2, characterized in that the rear face of the collar is provided with a thread recess, and in that the thread recess of the rear face is offset in the circumferential direction relative to the thread recess of the support face.

4. The composite capsule as claimed in claim 1, characterized in that the support face has two thread recesses, and in that the thread recesses are offset by 180°.

5. The composite capsule as claimed in claim 1, characterized by a plunger, which is designed to be introduced through the receiving opening into the receiving space.

6. The composite capsule as claimed in claim 1, characterized in that, in a front portion, the receiving space is cylindrical and, in a rear portion, it widens in the direction of the receiving opening.

7. The composite capsule as claimed in claim 1, characterized by a dispensing tip, which is inclined with respect to the longitudinal axis of the composite capsule.

8. The composite capsule as claimed in claim 7, characterized in that there is an intersection between a projection of the dispensing tip into the plane of the support face and a projection of the thread groove into the plane of the support face.

9. The composite capsule as claimed in claim 7, characterized in that a cap fitting the dispensing tip is provided.

10. A system composed of a storage syringe and of a composite capsule as claimed in claim 1, characterized in that the storage syringe has a mating thread that matches the thread recess of the composite capsule, and in that the mating thread is arranged around a discharge channel of the storage syringe.

11. The system as claimed in claim 10, characterized in that the storage syringe has a tapering tip, and in that the tapering tip is adapted to the widening portion of the receiving space.

12. The system as claimed in claim 10, characterized in that it further comprises a dispensing pistol, wherein the dispensing pistol comprises a capsule receiver for the composite capsule, which capsule receiver has a mating face cooperating with the support face of the composite capsule.

13. The system as claimed in claim 12, characterized in that the mating face has a recess through which the composite capsule can be guided in the radial direction.

14. The system as claimed in claim 13, characterized in that the composite capsule is oriented in the capsule receiver in such a way that the thread groove of the composite capsule is arranged in the area of the recess of the mating face.

15. A method for dispensing a dental compound, with the following steps:
a. attaching a composite capsule to a storage container, wherein the composite capsule is connected to the storage container by a threaded connection;
b. dispensing dental compound from the storage container, such that the dental compound passes into a receiving space of the composite capsule;
c. closing the receiving space with a plunger;
d. inserting the composite capsule into a capsule receiver of a dispensing pistol;
e. actuating the dispensing pistol in order to exert pressure on the plunger, such that dental compound emerges from the composite capsule.

16. The composite capsule as claimed in claim 2, characterized by a collar extending about the circumference of the receiving space, wherein the support face forms the front face of the collar.

17. The composite capsule as claimed in claim 3, characterized by a collar extending about the circumference of the receiving space, wherein the support face forms the front face of the collar.

18. The composite capsule as claimed in claim 2, characterized by a plunger, which is designed to be introduced through the receiving opening into the receiving space.

19. The composite capsule as claimed in claim 3, characterized by a plunger, which is designed to be introduced through the receiving opening into the receiving space.

20. The composite capsule as claimed in claim 4, characterized by a plunger, which is designed to be introduced through the receiving opening into the receiving space.
